(19) United States
(12) Patent Application Publication
(10) Pub. No.: US 2026/0089637 A1
(43) Pub. Date: Mar. 26, 2026

(54) WAKE-UP SIGNAL SCHEME FOR WAKE-UP MANAGEMENT

(71) Applicant: Telefonaktiebolaget LM Ericsson (publ), Stockholm (SE)

(72) Inventors: Mohammad MOZAFFARI, Fremont, CA (US); Yanpeng YANG, Järfälla (SE); Kittipong KITTICHOKECHAI, Järfälla (SE); Mattias ANDERSSON, Sundbyberg (SE); Andreas HÖGLUND, Solna (SE)

(21) Appl. No.: 19/111,434

(22) PCT Filed: Sep. 20, 2023
(86) PCT No.: PCT/SE2023/050924

§ 371 Date: Mar. 13, 2025

Related U.S. Application Data
(60) Provisional application No. 63/408,293, filed on Sep. 20, 2022.

(51) Int. Cl. H04W 52/02; H04W 68/02; H04W 76/28

(52) U.S. Cl. CPC H04W 52/0235; H04W 68/02; H04W 76/28

(57) ABSTRACT

A method, system and apparatus are disclosed. A network node is configured to communicate with a wireless device. The network node is configured to configure the wireless device according to a wake-up signal, WUS, scheme, the WUS scheme configured for at least one of: reducing an occurrence of a false wake-up of a main radio of the wireless device; configuring the wireless device with a no-wake-up window, the no-wake-up window having a time period during which a main radio of the wireless device is prevented from waking; and configuring the wireless device with an inactivity timer configured for, after the occurrence of the false wake up, keeping the main radio awake for the duration of the inactivity timer. The network node is configured to communicate with the wireless device based on the WUS scheme.

### TECHNICAL FIELD

The present disclosure relates to wireless communications, and in particular, to wake-up management for a wireless device include one or more a radios/receivers.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs.

Wake-up receiver (WUR) (e.g., a receiver at a wireless device), sometimes also referred to as ‘wake-up radio,’ pertains to enabling a low power receiver in wireless devices, which, in case of the detection of a wake-up signal (WUS), wakes up the main (baseband/RF/less power efficient) receiver to detect an incoming message, typically paging (e.g., physical downlink control channel (PDCCH) in paging occasions (PO), scheduling the paging message on physical downlink shared channel (PDSCH)). WUR may lower energy consumption and lengthen device battery life, or at a fixed energy consumption the downlink latency can be reduced (shorter DRX/duty-cycles and more frequent checks for incoming transmissions).

FIG. 1 shows an illustration of location of a WUS and the paging occasion to which it is associated.

In general, there are two approaches for detecting WUS:
Using the main receiver (e.g., a first receiver)
   No need for additional dedicated hardware/receiver for monitoring WUS
   Coverage of the main receiver is not typically impacted
   Limited power saving gain as the main receiver monitors WUS
Having a dedicated receiver (WUR):
   Extremely low power, simple and low-cost receiver architecture, relaxed requirements, noisier (i.e., less accurate) clock or oscillator
   Significant power saving gain can be achieved by maximizing the time in which the main receiver can be in the sleep mode
   Enablers for zero energy/battery-less devices, and energy harvesting operations.
   There are coverage considerations given the tradeoff between WUR power consumption and sensitivity.

### WUS for NB-IoT and LTE-M

### 3GPP Release 15 (Rel-15)

In 3GPP Rel-15, WUS was specified for narrow band internet of things (NB-IoT) and long term evolution for machines (LTE-M). A motivation was wireless device energy consumption reduction. With the coverage enhancement, PDCCH could be repeated many times. The WUS is relatively shorter and therefore requires less reception time for the wireless device. A wireless device would check for a WUS a certain time before its PO. If a WUS is detected, the wireless device would continue to check for PDCCH in the PO. If not, which is most of the time, the wireless device can go back to a sleep state to conserve energy. Due to the coverage enhancements, the WUS can be of variable length depending on the wireless device's coverage. FIG. 2 shows an illustration of WUS for NB-IoT and LTE-M.

A ‘Wake-up signal’ (WUS) is based on the transmission of a short signal that indicates to the wireless device that it should continue to decode the downlink (DL) control channel e.g., full NPDCCH for NB-IoT. If such signal is absent (DTX, i.e., wireless device does not detect it) then the wireless device can go back to sleep without decoding the DL control channel. The decoding time for a WUS is considerably shorter than that of the full narrowband physical downlink control channel (NPDCCH) since it usually only needs to contain one bit of information, whereas the NPDCCH may contain up to 35 bits of information. This, in turn, reduces wireless device power consumption and leads to longer wireless device battery life. The WUS is typically transmitted only when there is a paging for the wireless device. But if there is no paging for the wireless device, then the WUS is not transmitted (i.e., implying a discontinuous transmission (DTX)). In that case, the wireless device would go back to deep sleep e.g., upon detecting DTX instead of WUS. This is illustrated in FIG. 1, blocks outside the broken-lined rectangle indicate possible WUS and PO positions, and blocks within the broken-lined rectangle indicate actual WUS and PO positions.

The specification of Rel-15 WUS is spread out over several parts of the long term evolution (LTE) 36-series standard, e.g., 3GPP TS 36.211, 36.213, 36.304 and 36.331.

### WUS UE Grouping Objective in 3GPP Rel-16

In the 3GPP Rel-16 work item description (WID), it was agreed that WUS should be further developed to also include wireless device grouping, such that the number of wireless devices that are triggered by a WUS is further narrowed down to a smaller subset of the wireless device s that are associated with a specific PO.

This can reduce the false paging rate, i.e., avoid a given wireless device being unnecessarily woken up by a WUS transmission intended for another wireless device. This feature is referred to in 3GPP Rel-16 as group WUS (GWUS). However, this is not directly related to WUR.

### 3GPP Rel-17 NR PEI

In 3GPP Rel-17, discussions started on introducing a WUS for new radio (NR), then-called “Paging Early Indication” (PEI). However, since at the time no coverage enhancement was specified for NR, the only gain for 3GPP Rel-17 PEI was for scenarios where the small fraction of wireless devices are in bad coverage and with large synchronization error due to the use of longer DRX cycles. The gain for such wireless devices were that, with the use of PEI, they would typically only have to acquire one synchronization signal block (SSB) before decoding PEI. This is instead of up to three SSBs if PEI is not used (a value often defined by wireless device vendors). So, for most wireless devices, Rel-17 PEI would result in gains or increased performance.

3GPP Rel-17 PEI will also support wireless devices grouping for false paging reduction, similar to the 3GPP Rel-16 GWUS above, which will have some gains at higher paging load.

In 3GPP RAN #93e it was discussed that PEI will be PDCCH-based, as seen in the next subsection, making it much less relevant to WUR (i.e., the main baseband receiver is required for decoding PEI).

### 3GPP Rel-18 NR WUR

3GPP Rel-18 concerns WUR for NR and improving energy efficiency compared to solutions specified in earlier releases. As explained above, generally the specification support needed to be able to use a WUR in the wireless device, the specification of a WUS and a long enough time gap between the WUS and the PDCCH in the PO (to allow the wireless device to start up the main receiver). Therefore, the main difference from 3GPP Rel-17 PEI is the WUS in 3GPP Rel-18 should not be PDCCH-based and should allow for a simpler (low complexity), low power receiver, i.e., WUR with simple modulation and detection techniques (e.g., using on-off keying (OOK) modulation and non-coherent detection).

In 3GPP Rel-18, a study item on “low-power wake-up signal and receiver for NR” was approved. The relevant justification and objective sections of 3GPP RP-213645 are described below. It should be understood that UE is interchangeable for wireless device. ():

### Justification

5G systems are designed and developed targeting for both mobile telephony and vertical use cases. Besides latency, reliability, and availability, UE energy efficiency may also be critical to 5G. Currently, 5G devices may have to be recharged per week or day, depending on individual's usage time. In general, 5G devices consume tens of milliwatts in RRC idle/inactive state and hundreds of milliwatts in RRC connected state. Designs to prolong battery life is a necessity for improving energy efficiency as well as for better user experience.

Energy efficiency is even more critical for UEs without a continuous energy source, e.g., UEs using small rechargeable and single coin cell batteries. Among vertical use cases, sensors and actuators are deployed extensively for monitoring, measuring, charging, etc. Generally, their batteries are not rechargeable and expected to last at least few years as described in 3GPP Technical Report (TR) 38.875. Wearables include smart watches, rings, eHealth related devices, and medical monitoring devices. With typical battery capacity, it is challenging to sustain up to 1-2 weeks as required.

The power consumption depends on the configured length of wake-up periods, e.g., paging cycle. To meet the battery life requirements above, eDRX cycle with large value is expected to be used, resulting in high latency, which is not suitable for such services with requirements of both long battery life and low latency. For example, in fire detection and extinguishment use case, fire shutters are closed and fire sprinklers are turned on by the actuators within 1 to 2 seconds from the time the fire is detected by sensors, long eDRX cycle cannot meet the delay requirements. eDRX is apparently not suitable for latency-critical use cases. Thus, the intention is to study ultra-low power mechanism that can support low latency in Rel-18, e.g., lower than eDRX latency.

Currently, UEs need to periodically wake up once per DRX cycle, which dominates the power consumption in periods with no signaling or data traffic. If UEs are able to wake up only when they are triggered, e.g., paging, power consumption could be dramatically reduced. This can be achieved by using a wake-up signal to trigger the main radio and a separate receiver which has the ability to monitor wake-up signal with ultra-low power consumption. Main radio works for data transmission and reception, which can be turned off or set to deep sleep unless it is turned on.

The power consumption for monitoring wake-up signal depends on the wake-up signal design and the hardware module of the wake-up receiver used for signal detecting and processing.

The study may primarily target low-power WUS/WUR for power-sensitive, small form-factor devices including IoT use cases (such as industrial sensors, controllers) and wearables. Other use cases are not precluded, e.g., XR/smart glasses, smart phones.

### Objective of SI

As opposed to the work on UE power savings in previous 3GPP releases, this study will not require existing signals to be used as WUS. All WUS solutions identified may be able to operate in a cell supporting legacy UEs. Solutions may target substantial gains compared to the existing Rel-15/16/17 UE power saving mechanisms. Other aspects such as detection performance, coverage, UE complexity, should be covered by the evaluation.

The study item includes the following objectives:
Identify evaluation methodology (including the use cases) & KPIs [RAN1]
   Primarily target low-power WUS/WUR for power-sensitive, small form-factor devices including IoT use cases (such as industrial sensors, controllers) and wearables
      Other use cases are not precluded
Study and evaluate low-power wake-up receiver architectures [RAN1, RAN4]
Study and evaluate wake-up signal designs to support wake-up receivers [RAN1, RAN4]
Study and evaluate L1 procedures and higher layer protocol changes needed to support the wake-up signals [RAN2, RAN1]
Study potential UE power saving gains compared to the existing Rel-15/16/17 UE power saving mechanisms and their coverage availability, as well as latency impact. System impact, such as network power consumption, coexistence with non-low-power-WUR UEs, network coverage/capacity/resource overhead should be included in the study [RAN1]
   Note: The need for RAN2 evaluation may be triggered by RAN1 when necessary.

One benefit of WUR is reduction of the energy consumption of the receiver, such that, unless there is any paging and data for the wireless device, it can remain in a power-saving state. This will extend the battery life of the device, or alternatively enable shorter downlink latency (shorter DRX) at a fixed battery life. For short-range communication, the WUR power can be low enough (˜10 uW) that this can even, in combination with energy harvesting, enable the WUR is continuously on (i.e., DRX or duty-cycling is not used) without the need for a battery. This can be considered as an enabler of battery-less devices towards 6G.

### IEEE WUR

In standards propagated by the Institute of Electrical and Electronics Engineers (IEEE) the support for WUR has been specified to a greater extent than in 3GPP. That is, the focus was on low-power WUR from start, and the design uses WUR not only for receiving the WUS but also other control signals and signaling, such as synchronization and mobility information. This allows the stations (corresponding to wireless devices in 3GPP) to only use the WUR when there is no user-plane data transmission ongoing.

Similar to the 3GPP approach, the use of WUR is enabled in stations and not in access points (APs), which is for downlink communication. The AP advertises that it has WUR operation capability, along with WUR configuration parameters (among other info, in which band/channel WUR is operational, which can be different from the band/channel used for data transmission using the main receiver, e.g., WUR in 2.4 GHz band but data communication in 5 GHz band. Also note that the WUR operating channel is advertised in the beacon, and that the WUR discovery operating channel may be different from the WUR operating channel.). Stations can then request to be configured with WUR mode of operation. This request has to be granted by the AP, and in case it is granted, the station is further configured/setup for WUR mode of operation (the configuration is only valid for the connection to the associated AP, and further the configuration must be torn down/de-configured if WUR is not used anymore). Both continuous WUR (receiver open all the time) and duty-cycled WUR (receiver only open during preconfigured time slots) mode of operations are supported. For the latter the length of the duty-cycles and on-time during wake up is part of the WUR configuration.

Unlike the 3GPP solution, the WUR operation mode is a “sub-state” of the regular operation and upon the detection of a WUS transmission from the AP, the station will resume the power-saving mechanism it was configured with before entering the WUR operation mode. That is, IEEE has specified a number of different power saving mechanisms, and for example if duty-cycled monitoring of the downlink has been configured for the station (e.g., wireless device) it will switch to that upon detection of the WUS (i.e., unlike the specified 3GPP mechanism which only covers paging, and the UE will continue to monitor PDCCH if WUS is detected). In this way the IEEE WUR functionality is more general, and still allows for the station to upon detection of WUS “monitor paging” by checking in the beacon from the AP for which stations there is data, or for the station to directly respond with an uplink transmission.

The physical wake-up signal (WUS) in IEEE contains complete frames which must be processed by the station. The drawback with this design is that it requires more handling and processing in the station, i.e., compared to a simple WUR design which triggers one pre-defined activity in case WUS is detected. The benefit is that it contains more information, and the solution is more general. The IEEE WUS contains information to indicate if the WUS is a WUR sync beacon, a WUR discovery beacon, or a regular WUS (intended to wake the station up). The WUS can also contain proprietary frames, which could, e.g., be used to directly turn actuators on/off. The transmission uses on/off keying (OOK) modulation, using Manchester coding, but is using multi-carrier OOK, which can be generated by an orthogonal frequency-division multiplexing (OFDM) transmitter (i.e., WUR can be enabled as a software upgrade in APs). The WUS is 4 MHz wide, but a whole 20 MHz channel is reserved. The WUS starts with a 20 MHz legacy preamble (to allow other stations to perform carrier sense) followed by 4 MHz Manchester coded OOK. Two data rates are supported: 62.5 kbps and 250 kbps, and link adaptation is up to the AP (each packet is self-contained and includes the data rate, i.e., in the WUR there are two possible sync words used to signal the data rate).

### Power Vs. Sensitivity Tradeoff

The design challenge in receivers for IoT applications is to minimize the power consumption with an adequate sensitivity level. In WUR design, receiver sensitivity may be an important parameter, as it provides the lowest power level at which the receiver can detect a WUS. Generally, high sensitivity requires more power consuming electronics (e.g., low noise amplifier (LNA)) at the receiver side, thus high power demand. In contrast, low sensitivity for the same communication range will require high radiated power at the transmitter side. Because of this, sensitivity requirements often lead to over-design to ensure reliable communication in adverse conditions. When the WUR is used to trigger a less energy-efficient and more power consuming main receiver, ideally the WUR and the main receiver may have the same range.

As an example as shown in FIG. 3, the tradeoff between sensitivity/coverage and energy consumption of WUR is based on the existing low-power radio designs. For every 20 dB improvement in sensitivity, there is at least a 10× increase in power consumption.

### Energy Consumption vs. Latency Tradeoff

Another tradeoff in WUR design and operation is energy consumption versus latency. For example, to achieve a minimum latency, WUR may need to be always ON to continuously monitor for downlink transmissions (e.g., WUS). The average power consumption can be reduced by relaxing latency and allowing the WUR to go to sleep modes.

### Impact of False Wake-Up

In general, false wake-ups are caused due to false alarms and false paging as defined below:
False alarm: physical (PHY)-layer effect of WUS incorrectly being received when there is none (single wireless device effect).
False paging: higher layer (HL)-effect of WUS to one wireless device unnecessarily waking up other wireless devices sharing the same WUS resource (multi-UE effect or multi-wireless-device effect).

The WUR has specific sensitivity, detection, and false alarm performance. Depending on the design of WUR, it performs reception/detection in specific time intervals (e.g., every x ms). The outcome of each trial can be (as shown in FIG. 4): 1) WUS is correctly detected, 2) WUS is present but not detected (miss detection), 3) WUS is not present but WUR declares WUS is detected (false alarm), and 4) WUS is not present and WUR does not detect it (correct rejection).

In addition to false alarm effect, false paging can happen as a WUS intended for one wireless device unnecessarily wakes up other wireless devices sharing the same WUS resource (multi-wireless device effect).

In case of false alarm, false paging or in general false wake ups, the WUR falsely detects a WUS and triggers the main radio to wake up and monitor an incoming signal. Such false wake ups result in an additional power consumption, thus decreasing the potential gain of WUR. For example, FIG. 5 shows that the power saving gain of WUR significantly decreases as the false alarm probability and the number of false wake ups increases.

However, though employing WUR can provide significant power saving for the wireless device, its performance is highly susceptible to false alarm events for which the main radio is mistakenly woken up. Since a wireless device (i.e., main radio) consumes a considerable amount of energy for ramping up/down, false alarm events can result in additional wireless device power consumption (or even negative power saving gain). Therefore, employing a WUR may not have any benefit in certain cases, but, in some cases, may also drain the wireless device battery.

Hence, existing WUR mechanisms and/or processes are not without issues.

### SUMMARY

Some embodiments advantageously provide methods, systems, and apparatuses for wake-up management for a radio/wireless devices.

One way of addressing shortcomings of WUR is by reducing the occurrence of false alarm events.

The present disclosure presents solutions for reducing the effects of false alarms when employing wake-up radios for the purpose of wireless device energy efficiency with latency constraints. Moreover, the solutions allow an efficient multiplexing of multiple wake-up radios while minimizing the number of false wake ups. Specifically, one or more embodiments described herein include new enhancements and new/adaptive configurations for the following aspects:
WUR multiplexing/separation techniques such as:
   Enhancements for group wake up mechanism
   WUS time-frequency resources
      Different WUS duration
      Different WUS occasions
      Different WUS bandwidths
      Different sets of contagious or non-contiguous frequency resources
      Considering multiple interleaving patterns in frequency domain.
   Multiple duty-cycle configurations for WUR operation
      Different DRX parameters such as on duration, off duration, duty cycle length/periodicity.
Introducing no-wake up window for false alarm reduction

Various embodiments in accordance with the present disclosure confer benefits, including but not limited to:
1) Improving wireless device energy efficiency by minimizing the effect of false alarms when employing WUR.
2) Increasing multiplexing capacity for WUR operation.
3) Efficient use of WUR to maximize the power saving gain while maintaining the wireless device coverage in various deployment scenarios.
4) Network flexibility for properly employing WUR based on various requirements such coverage, energy efficiency, and latency.
5) The solutions described herein can be considered as an enabler of battery-less (zero-energy) devices and energy harvesting operations towards 5G Advanced and 6G.

According to one aspect of the present disclosure, a network node configured to communicate with a wireless device is provided. Network node is configured to: configure the wireless device according to a wake-up signal, WUS, scheme, the WUS scheme configured for at least one of: reducing an occurrence of a false wake-up of a main radio of the wireless device by at least one of: assigning the wireless device to a group of wireless devices based on a common characteristic, the wireless devices of the group being configured to wake based on receiving a WUS; configuring the wireless device with a first set of time-frequency resources for a first WUS, the first set of time-frequency resources being different from a second set of time-frequency resources used by another wireless device for a second WUS; and configuring the wireless device with a first wake-up radio, WUR, discontinuous reception, DRX, cycle different from a second WUR DRX cycle of the another wireless device; configuring the wireless device with a no-wake-up window, the no-wake-up window having a time period during which a main radio of the wireless device is prevented from waking; and configuring the wireless device with an inactivity timer configured for, after the occurrence of the false wake up, keeping the main radio awake for the duration of the inactivity timer. Network node is configured to communicate with the wireless device based on the WUS scheme.

According to one or more embodiments of this aspect, the common characteristic is at least one of a traffic pattern, a paging occasion, PO, and a WUS window.

According to one or more embodiments of this aspect, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

According to one or more embodiments of this aspect, the first WUR DRX cycle and the second WUR DRX cycle differ based on at least one of: different respective DRX start times; different respective DRX-inactivity timers; different respective DRX ON durations; and different respective DRX OFF durations.

According to one or more embodiments of this aspect, configuring the wireless device with an inactivity timer further includes configuring the wireless device to cause the main radio to sleep when at least one of: the wireless device detects no activity during the duration of the inactivity timer; and the wireless device receives, at the earliest PO following the false wake-up, no physical downlink control channel, PDCCH, signal associated with the false wake-up.

According to another aspect of the present disclosure, a method implemented in a network node configured to communicate with a wireless device is provided. The method includes: configuring the wireless device according to a wake-up signal, WUS, scheme, the WUS scheme configured for at least one of: reducing an occurrence of a false wake-up of a main radio of the wireless device by at least one of: assigning the wireless device to a group of wireless devices based on a common characteristic, the wireless devices of the group being configured to wake based on receiving a WUS; configuring the wireless device with a first set of time-frequency resources for a first WUS, the first set of time-frequency resources being different from a second set of time-frequency resources used by another wireless device for a second WUS; and configuring the wireless device with a first wake-up radio, WUR, discontinuous reception, DRX, cycle different from a second WUR DRX cycle of the another wireless device; configuring the wireless device with a no-wake-up window, the no-wake-up window having a time period during which a main radio of the wireless device is prevented from waking; and configuring the wireless device with an inactivity timer configured for, after the occurrence of the false wake up, keeping the main radio awake for the duration of the inactivity timer. The method includes communicating with the wireless device based on the WUS scheme.

According to one or more embodiments of this aspect, the common characteristic is at least one of a traffic pattern, a paging occasion, PO, and a WUS window.

According to one or more embodiments of this aspect, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

According to one or more embodiments of this aspect, the first WUR DRX cycle and the second WUR DRX cycle differ based on at least one of: different respective DRX start times; different respective DRX-inactivity timers; different respective DRX ON durations; and different respective DRX OFF durations.

According to one or more embodiments of this aspect, configuring the wireless device with an inactivity timer further includes configuring the wireless device to cause the main radio to sleep when at least one of: the wireless device detects no activity during the duration of the inactivity timer; and the wireless device receives, at the earliest PO following the false wake-up, no physical downlink control channel, PDCCH, signal associated with the false wake-up.

According to another aspect of the present disclosure, a wireless device configured to communicate with a network node is provided. Wireless device is configured to:
receive a wake-up signal, WUS, scheme, the WUS scheme configured for at least one of: reducing an occurrence of a false wake-up of a main radio of the wireless device by at least one of: assigning the wireless device to a group of wireless devices based on a common characteristic, the wireless devices of the group being configured to wake based on receiving a WUS; configuring the wireless device with a first set of time-frequency resources for a first WUS, the first set of time-frequency resources being different from a second set of time-frequency resources used by another wireless device for a second WUS; and configuring the wireless device with a first wake-up radio, WUR, discontinuous reception, DRX, cycle different from a second WUR DRX cycle of the another wireless device; configuring the wireless device with a no-wake up window, the no-wake up window having a time period during which a main radio of the wireless device is prevented from waking; and configuring the wireless device with an inactivity timer configured for, after the occurrence of the false wake up, keeping the main radio awake for the duration of the inactivity timer. Wireless device is configured to communicate with the network node based on the WUS scheme.

According to one or more embodiments of this aspect, the common characteristic is at least one of a traffic pattern, a paging occasion, PO, and a WUS window.

According to one or more embodiments of this aspect, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

According to one or more embodiments of this aspect, the first WUR DRX cycle and the second WUR DRX cycle differ based on at least one of: different respective DRX start times; different respective DRX-inactivity timers; different respective DRX ON durations; and different respective DRX OFF durations.

According to one or more embodiments of this aspect, configuring the wireless device with an inactivity timer further includes configuring the wireless device to cause the main radio to sleep when at least one of: the wireless device detects no activity during the duration of the inactivity timer; and the wireless device receives, at the earliest PO following the false wake-up, no physical downlink control channel, PDCCH, signal associated with the false wake-up.

According to another aspect of the present disclosure, a method implemented in a wireless device configured to communicate with a network node is provided. The method includes: receiving a wake-up signal, WUS, scheme, the WUS scheme configured for at least one of: reducing an occurrence of a false wake-up of a main radio of the wireless device by at least one of: assigning the wireless device to a group of wireless devices based on a common characteristic, the wireless devices of the group being configured to wake based on receiving a WUS; configuring the wireless device with a first set of time-frequency resources for a first WUS, the first set of time-frequency resources being different from a second set of time-frequency resources used by another wireless device for a second WUS; and configuring the wireless device with a first wake-up radio, WUR, discontinuous reception, DRX, cycle different from a second WUR DRX cycle of the another wireless device; configuring the wireless device with a no-wake up window, the no-wake up window having a time period during which a main radio of the wireless device is prevented from waking; and configuring the wireless device with an inactivity timer configured for, after the occurrence of the false wake up, keeping the main radio awake for the duration of the inactivity timer. The method includes communicating with the network node based on the WUS scheme.

According to one or more embodiments of this aspect, the common characteristic is at least one of a traffic pattern, a paging occasion, PO, and a WUS window.

According to one or more embodiments of this aspect, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

According to one or more embodiments of this aspect, the first WUR DRX cycle and the second WUR DRX cycle differ based on at least one of: different respective DRX start times; different respective DRX-inactivity timers; different respective DRX ON durations; and different respective DRX OFF durations.

According to one or more embodiments of this aspect, configuring the wireless device with an inactivity timer further includes configuring the wireless device to cause the main radio to sleep when at least one of: the wireless device detects no activity during the duration of the inactivity timer; and the wireless device receives, at the earliest PO following the false wake-up, no physical downlink control channel, PDCCH, signal associated with the false wake-up.

According to another aspect of the present disclosure, a computer program including instructions is provided which, when executed on at least one processor, cause the at least one processor to carry out one or more of the foregoing methods.

According to another aspect of the present disclosure, a carrier containing the foregoing computer program is provided, wherein the carrier is one of an electronic signal, optical signal, radio signal, or computer-readable medium.

According to another aspect of the present disclosure, a computer-readable medium including instructions is provided which, when executed on at least one processor, cause the at least one processor to carry out one or more of the foregoing methods.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of a WUS and associated paging occasion;

FIG. 2 is a schematic diagram of a WUS for NB-IoT and LTE-M;

FIG. 3 graphical representation of power vs. sensitivity for low power radios;

FIG. 4 is a schematic diagram of WUS detection cases.

FIG. 5 is a schematic diagram of the impact of WUR false alarm probability on power saving gain;

FIG. 6 is a schematic diagram of an example network architecture illustrating a communication system connected via an intermediate network to a host computer according to the principles in the present disclosure;

FIG. 7 is a block diagram of a host computer communicating via a network node with a wireless device over an at least partially wireless connection according to some embodiments of the present disclosure;

FIG. 8 is a flowchart illustrating example methods implemented in a communication system including a host computer, a network node and a wireless device for executing a client application at a wireless device according to some embodiments of the present disclosure;

FIG. 9 is a flowchart illustrating example methods implemented in a communication system including a host computer, a network node and a wireless device for receiving user data at a wireless device according to some embodiments of the present disclosure;

FIG. 10 is a flowchart illustrating example methods implemented in a communication system including a host computer, a network node and a wireless device for receiving user data from the wireless device at a host computer according to some embodiments of the present disclosure;

FIG. 11 is a flowchart illustrating example methods implemented in a communication system including a host computer, a network node and a wireless device for receiving user data at a host computer according to some embodiments of the present disclosure;

FIG. 12 is a flowchart of an example process in a network node according to some embodiments of the present disclosure;

FIG. 13 is a flowchart of an example process in a wireless device according to some embodiments of the present disclosure;

FIG. 14 is a flowchart of another example process in a network node according to some embodiments of the present disclosure;

FIG. 15 is a flowchart of another example process in a wireless device according to some embodiments of the present disclosure;

FIG. 16 is a schematic diagram of a wake-up radio according to some embodiments of the present disclosure;

FIG. 17 is a schematic diagram of an example WUS window according to some embodiments of the present disclosure;

FIG. 18 is a schematic diagram of an example WUS window according to some embodiments of the present disclosure;

FIG. 19 is a schematic diagram of an example wireless device grouping according to some embodiments of the present disclosure;

FIG. 20 is a schematic diagram of an example of time domain resources according to some embodiments of the present disclosure;

FIG. 21 is a schematic diagram of an example of frequency domain resources according to some embodiments of the present disclosure;

FIG. 22 is a schematic diagram of an example of interleaved frequency resources according to some embodiments of the present disclosure;

FIG. 23 is a schematic diagram of an example of a DRX cycle according to some embodiments of the present disclosure;

FIG. 24 is a schematic diagram of an example of DRX according to some embodiments of the present disclosure; and

FIG. 25 is a schematic diagram of an example of a no-wake up window according to some embodiments of the present disclosure.

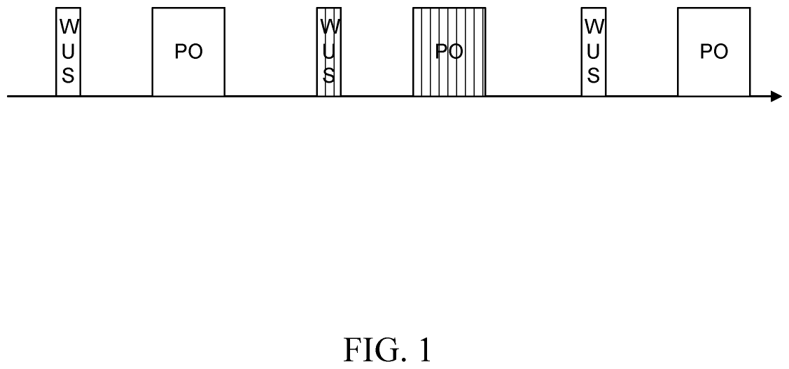

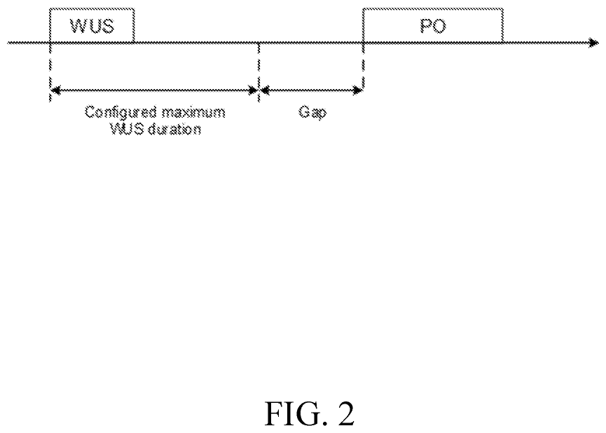

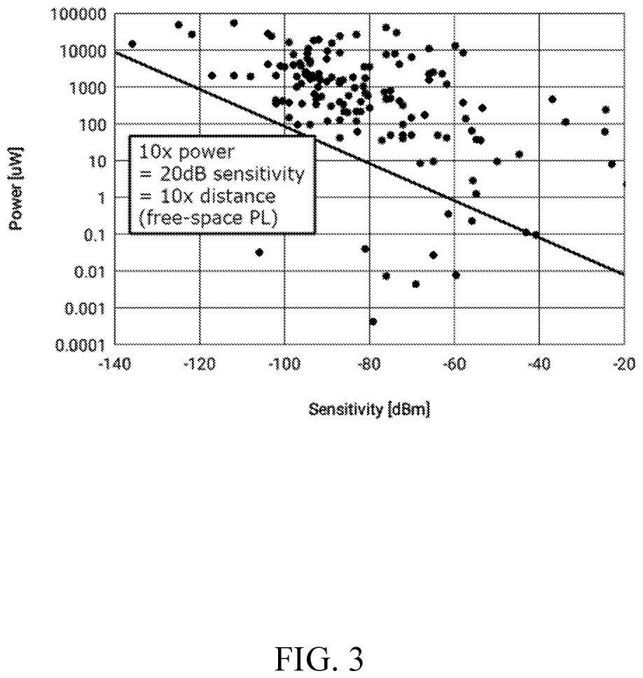

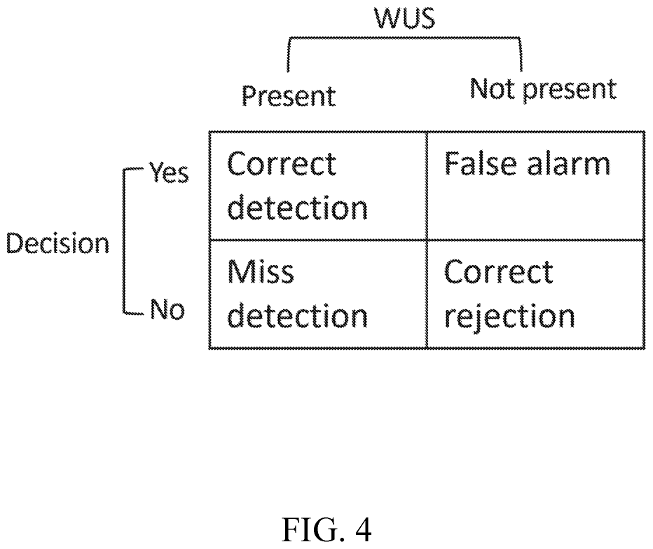

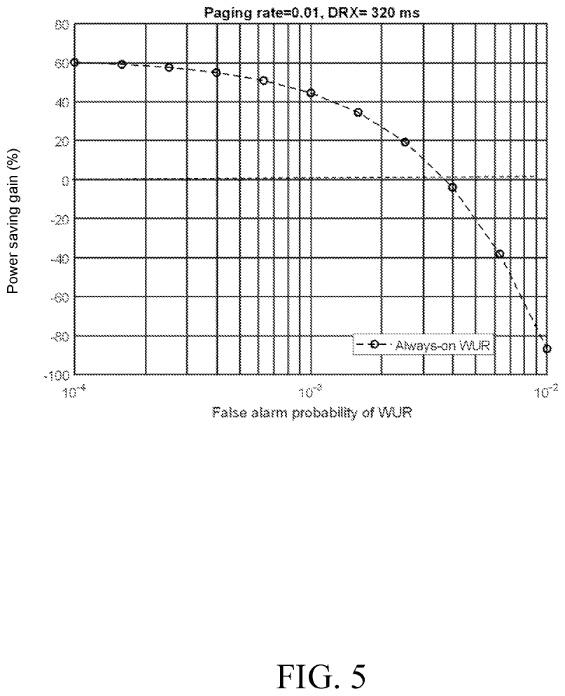

### DETAILED DESCRIPTION

Before describing in detail example embodiments, it is noted that the embodiments reside primarily in combinations of apparatus components and processing steps related to wake-up management for a wireless device including various radio/receivers. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), integrated access and backhaul (IAB) node, relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device, etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), IAB node, relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments provide for wake-up management for wireless device (e.g., one or more receivers/radios in a wireless device).

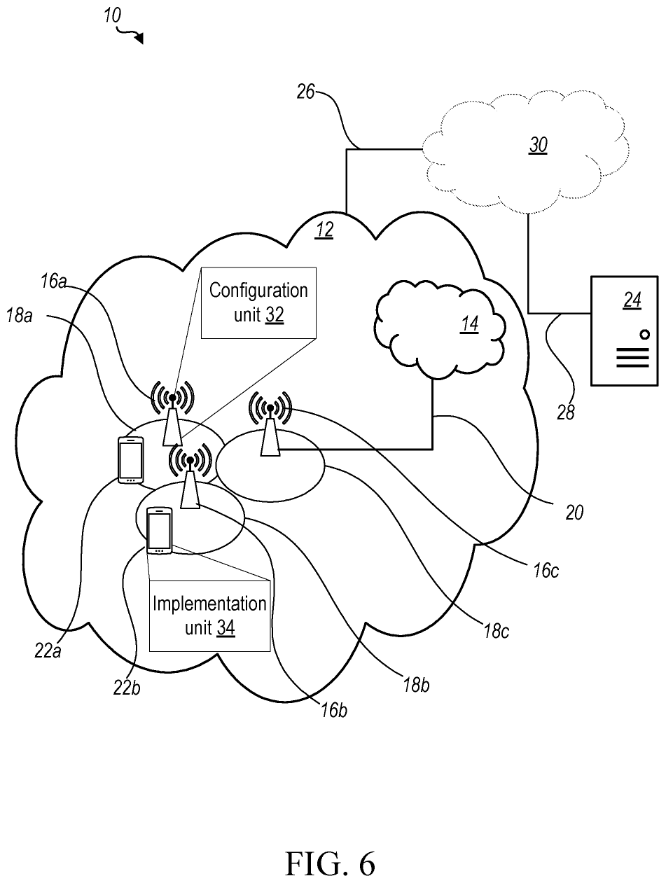

Referring now to the drawing figures, in which like elements are referred to by like reference numerals, there is shown in FIG. 6 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 6 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a configuration unit 32 which is configured to perform one or more network node 16 functions described herein, including, for example, functions related to wake-up management of a radio. A wireless device 22 is configured to include an implementation unit 34, which is configured to perform one or more wireless device 22 functions described herein, including, for example, functions related to wake-up management of a radio.

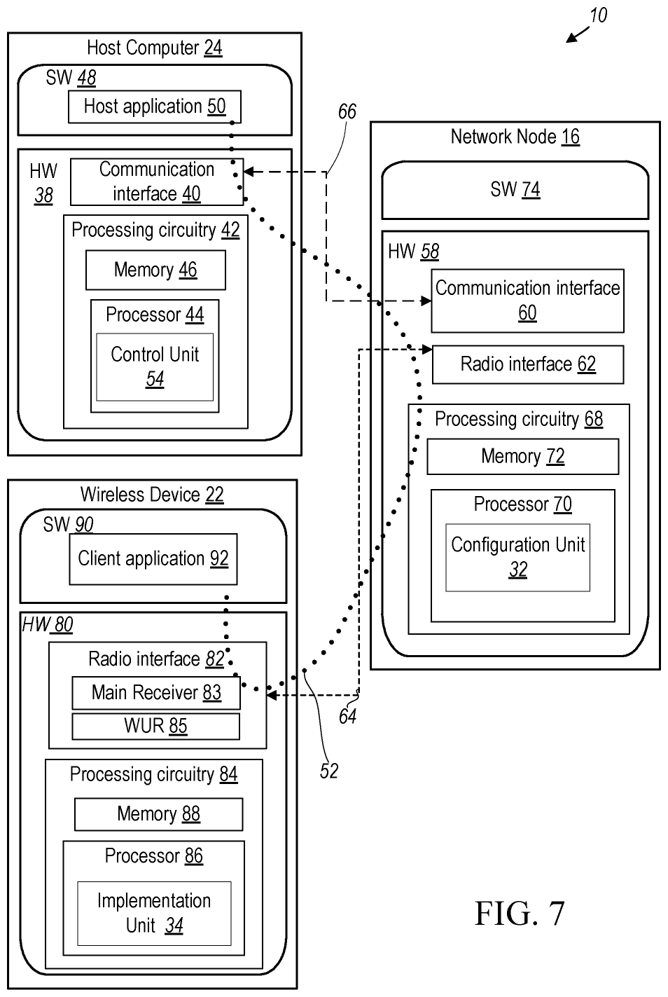

Example implementations, in accordance with an embodiment, of the WD 22, network node 16 and host computer 24 discussed in the preceding paragraphs will now be described with reference to FIG. 7. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a control unit 54 configured to enable the service provider to observe/monitor/control/transmit to/receive from the network node 16 and or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a configuration unit 32 configured to perform one or more network node 16 functions described herein, including functions related to wake-up management of a radio.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers. For example, radio interface 82 may include a main receiver 83 and a WUR (dedicated receiver) 85.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include an implementation unit 34 configured to perform one or more wireless device 22 functions described herein, including functions related to wake-up management of a radio.

In some embodiments, the inner workings of the network node 16, WD 22, and host computer 24 may be as shown in FIG. 7 and independently, the surrounding network topology may be that of FIG. 6.

In FIG. 7, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors, etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 6 and 7 show various “units” such as configuration unit 32, and implementation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

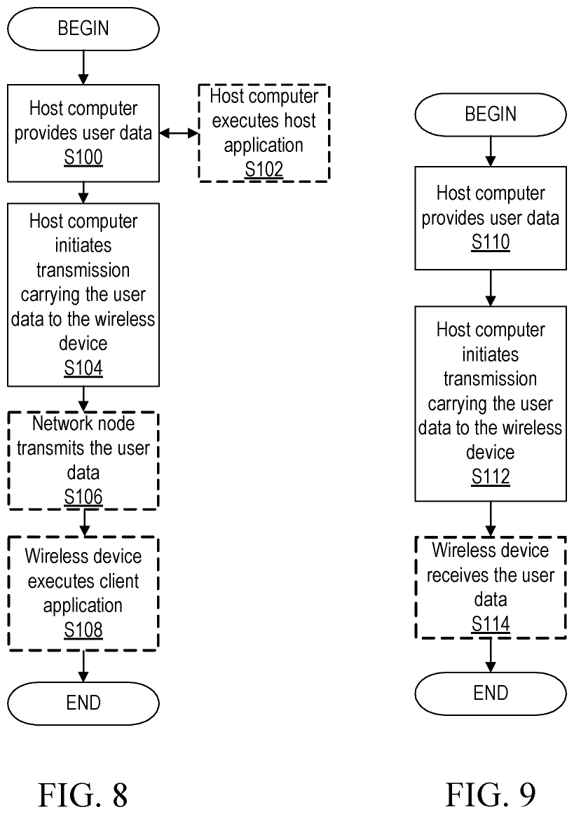

FIG. 8 is a flowchart illustrating an example method implemented in a communication system, such as, for example, the communication system of FIGS. 6 and 7, in accordance with one embodiment. The communication system may include a host computer 24, a network node 16 and a WD 22, which may be those described with reference to FIG. 7. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 9 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

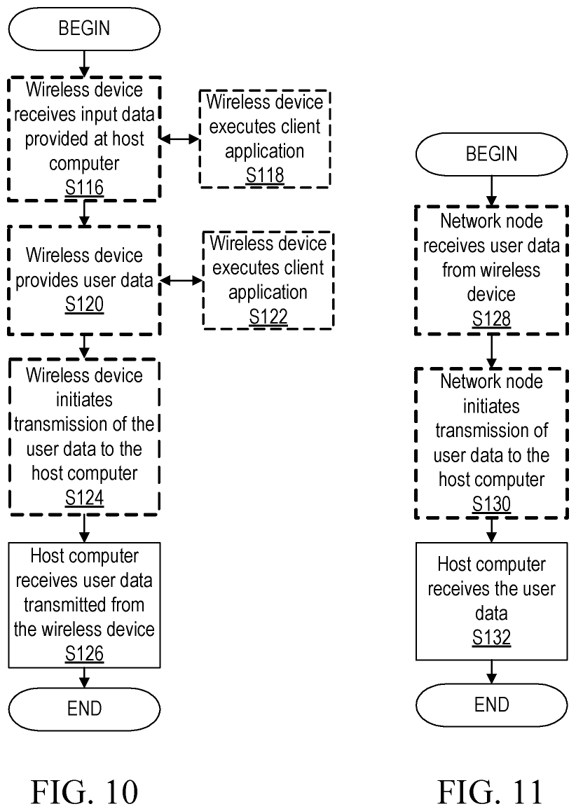

FIG. 10 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 11 is a flowchart illustrating an example method implemented in a communication system, such as, for example, the communication system of FIG. 6, in accordance with one embodiment. The communication system may include a host computer 24, a network node 16 and a WD 22, which may be those described with reference to FIGS. 6 and 7. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

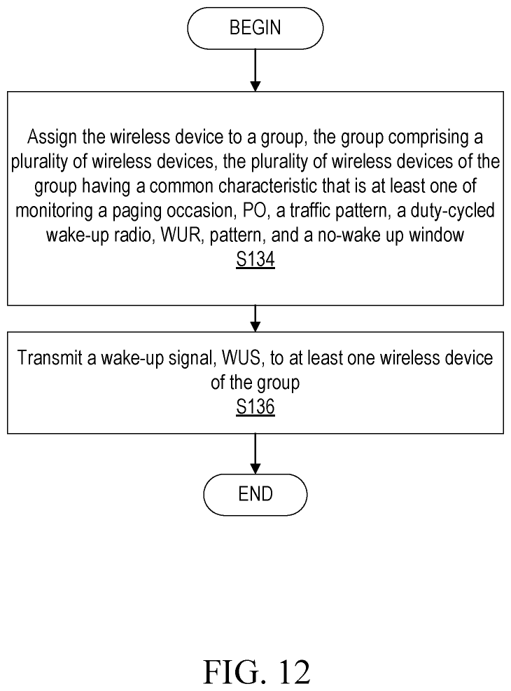

FIG. 12 is a flowchart of an example process in a network node 16. One or more blocks described herein may be performed by one or more elements of network node 16 such as by one or more of processing circuitry 68 (including the configuration unit 32), processor 70, radio interface 62 and/or communication interface 60. Network node 16 is configured to assign the wireless device 22 to a group, the group including a plurality of wireless devices 22, the plurality of wireless devices 22 of the group having a common characteristic that is at least one of monitoring a PO a traffic pattern, a duty-cycled WUR pattern, and a no-wake up window (Block S134). Network node 16 is further configured to transmit a WUS to at least one wireless device 22 of the group (Block S136).

In at least one embodiment, the network node 16 is further configured to configure the group of wireless devices 22 with a common WUS window. In at least one embodiment, the group has the common WUR pattern, the common WUR pattern being defined by a parameter including at least one of a DRX inactivity timer, DRX active time, and DRX inactive time.

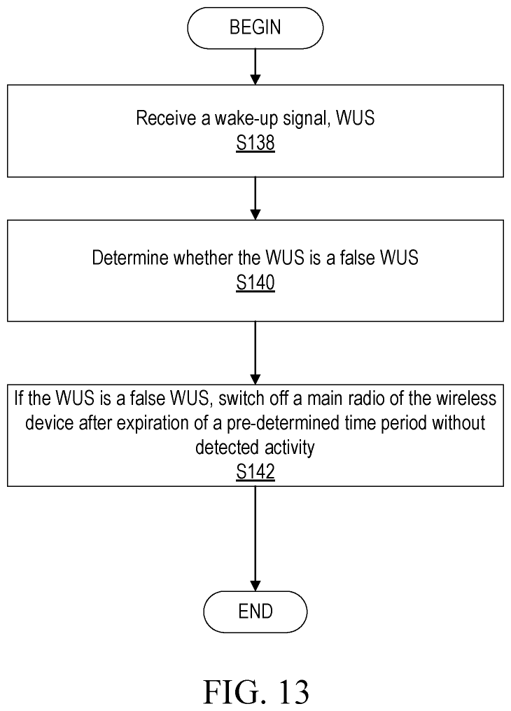

FIG. 13 is a flowchart of an example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive a WUS (Block S138) and determine whether the WUS is a false WUS (Block S140); and if the WUS is a false WUS, switch off a main radio of the wireless device 22 after expiration of a pre-determined time period without detected activity (Block S142).

In at least one embodiment, the detected activity includes at least one of a paging transmission and a PDSCH transmission. In at least one embodiment, the detected activity includes a PDCCH transmission corresponding to the WUS.

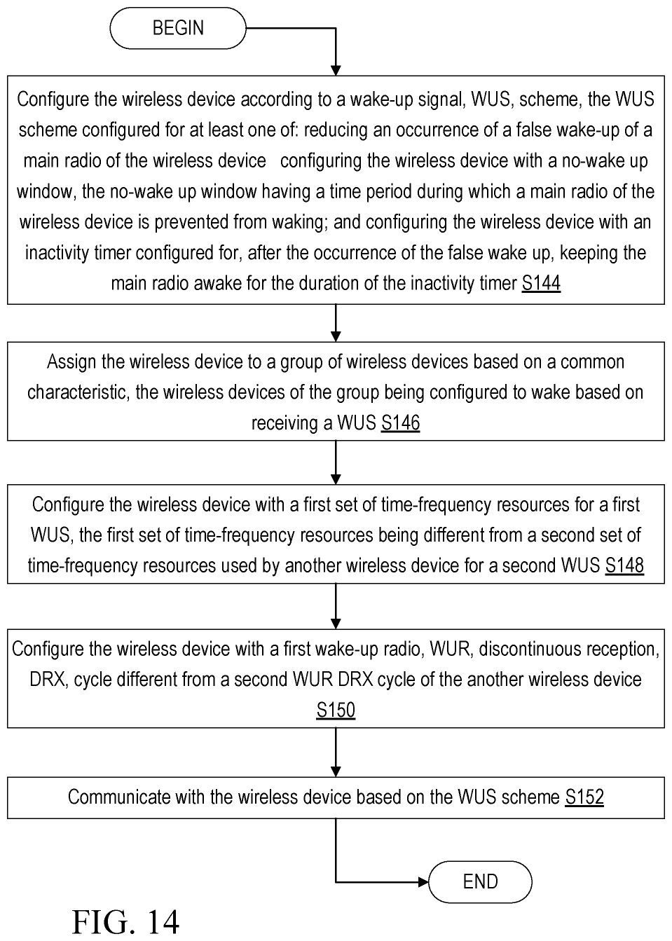

FIG. 14 is a flowchart of another example process in a network node 16. One or more blocks described herein may be performed by one or more elements of network node 16 such as by one or more of processing circuitry 68 (including the configuration unit 32), processor 70, radio interface 62 and/or communication interface 60. Network node 16 is configured to configure (Block S144) the wireless device according to a wake-up signal, WUS, scheme, the WUS scheme configured for at least one of: reducing an occurrence of a false wake-up of a main radio of the wireless device by at least one of: assigning (Block S146) the wireless device 22 to a group of wireless devices based on a common characteristic, the wireless devices of the group being configured to wake based on receiving a WUS; configuring (Block S148) the wireless device 22 with a first set of time-frequency resources for a first WUS, the first set of time-frequency resources being different from a second set of time-frequency resources used by another wireless device for a second WUS; and configuring (Block S150) the wireless device 22 with a first wake-up radio, WUR, discontinuous reception, DRX, cycle different from a second WUR DRX cycle of the another wireless device; configuring the wireless device 22 with a no-wake-up window, the no-wake-up window having a time period during which a main radio of the wireless device is prevented from waking; and configuring the wireless device 22 with an inactivity timer configured for, after the occurrence of the false wake up, keeping the main radio awake for the duration of the inactivity timer. Network node 16 is configured to communicate (Block S152) with the wireless device 22 based on the WUS scheme.

In at least one embodiment, the common characteristic is at least one of a traffic pattern, a paging occasion, PO, and a WUS window.

In at least one embodiment, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

In at least one embodiment, the first WUR DRX cycle and the second WUR DRX cycle differ based on at least one of: different respective DRX start times; different respective DRX-inactivity timers; different respective DRX ON durations; and different respective DRX OFF durations.

In at least one embodiment, configuring the wireless device 22 with an inactivity timer further includes configuring the wireless device 22 to cause the main radio to sleep when at least one of: the wireless device 22 detects no activity during the duration of the inactivity timer; and the wireless device 22 receives, at the earliest PO following the false wake-up, no physical downlink control channel, PDCCH, signal associated with the false wake-up.

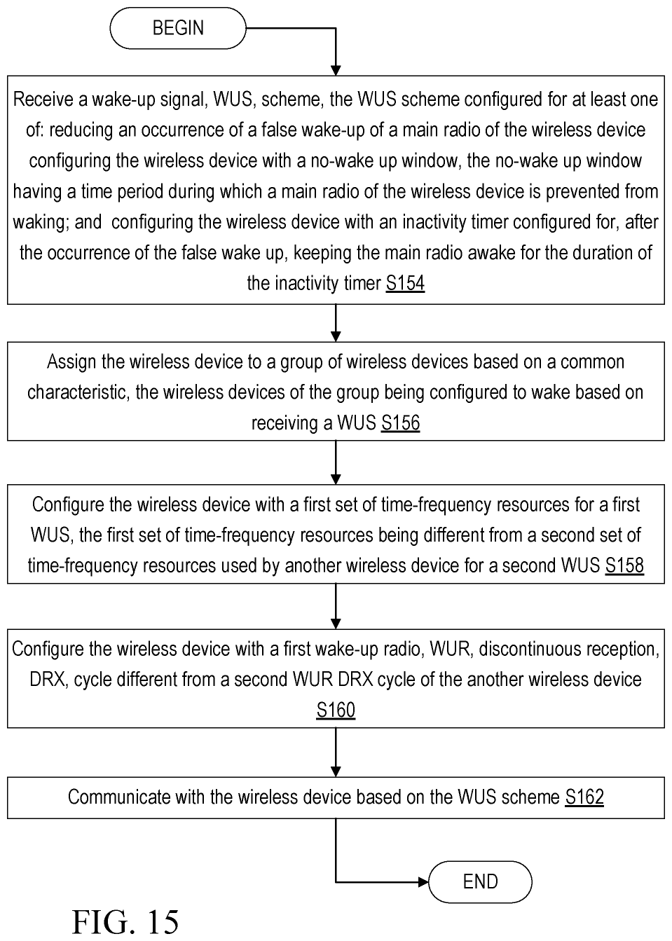

FIG. 15 is a flowchart of another example process in a wireless device 22 according to some embodiments of the present disclosure. One or more blocks described herein may be performed by one or more elements of wireless device 22 such as by one or more of processing circuitry 84 (including the implementation unit 34), processor 86, radio interface 82 and/or communication interface 60. Wireless device 22 is configured to receive (Block S154) a wake-up signal, WUS, scheme, the WUS scheme configured for at least one of: reducing an occurrence of a false wake-up of a main radio of the wireless device by at least one of: assigning (Block S156) the wireless device 22 to a group of wireless devices based on a common characteristic, the wireless devices of the group being configured to wake based on receiving a WUS; configuring (Block S158) the wireless device 22 with a first set of time-frequency resources for a first WUS, the first set of time-frequency resources being different from a second set of time-frequency resources used by another wireless device for a second WUS; and configuring (Block S160) the wireless device 22 with a first wake-up radio, WUR, discontinuous reception, DRX, cycle different from a second WUR DRX cycle of the another wireless device; configuring the wireless device 22 with a no-wake up window, the no-wake up window having a time period during which a main radio of the wireless device is prevented from waking; and configuring the wireless device 22 with an inactivity timer configured for, after the occurrence of the false wake up, keeping the main radio awake for the duration of the inactivity timer. Wireless device 22 is configured to communicate (Block S162) with the network node 16 based on the WUS scheme.

In at least one embodiment, the common characteristic is at least one of a traffic pattern, a paging occasion, PO, and a WUS window.

In at least one embodiment, the first set of time-frequency resources and the second set of time-frequency resources differ based on at least one of: different respective WUS durations; different respective WUS occasions; different respective physical resource blocks, PRBs; different respective WUS bandwidths; and different respective interleaving patterns.

In at least one embodiment, the first WUR DRX cycle and the second WUR DRX cycle differ based on at least one of: different respective DRX start times; different respective DRX-inactivity timers; different respective DRX ON durations; and different respective DRX OFF durations.

In at least one embodiment, configuring the wireless device 22 with an inactivity timer further includes configuring the wireless device 22 to cause the main radio to sleep when at least one of: the wireless device 22 detects no activity during the duration of the inactivity timer; and the wireless device 22 receives, at the earliest PO following the false wake-up, no physical downlink control channel, PDCCH, signal associated with the false wake-up.

Having described the general process flow of arrangements of the disclosure and having provided examples of hardware and software arrangements for implementing the processes and functions of the disclosure, the sections below provide details and examples of arrangements for wake-up management for a wireless device (e.g., for one or more radios at the wireless device 22). One or more wireless device 22 functions described below may be performed by one or more of processing circuitry 84, processor 86, implementation unit 34, etc. One or more network node 16 functions described below may be performed by one or more of processing circuitry 68, processor 70, configuration unit 32, etc.

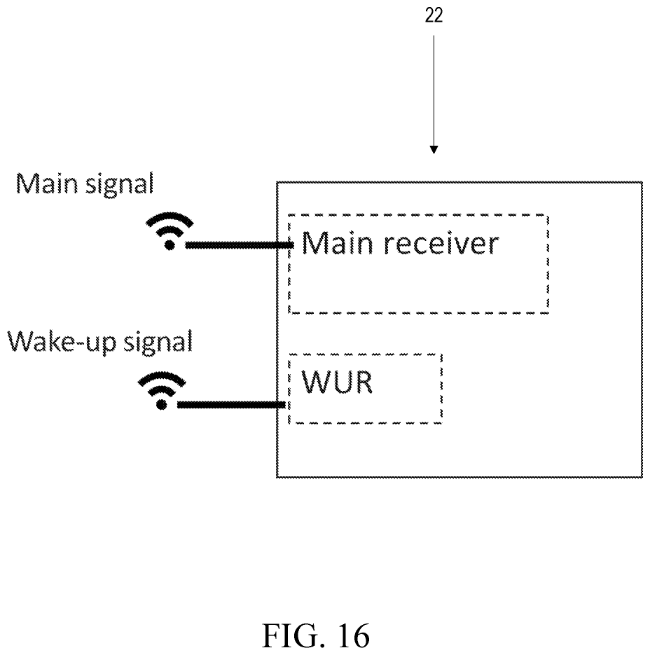

Some embodiments provide for a dedicated WUR 85 to be used for monitoring a WUS. Once WUR 85 detects the intended WUS, it wakes up the main (baseband/RF/less power efficient) receiver (of the, e.g., wireless device 22) to detect further incoming messages, as shown in FIG. 16. Therefore, the main receiver 83 (of the, e.g., wireless device 22) can enter sleep mode and save power until it is triggered by WUR 85. Given the sensitivity and power consumption tradeoff in designing WUS and/or WUR 85, the coverage of the WUR 85 may not be the same as that of the main radio/receiver.

### WUR Separation Techniques for False Paging Reduction

One approach to reduce the number of false wake ups is to separate (or distinguish) different WUSs such that the network, e.g., via a network node 16, only wakes up the wireless devices 22 that need to be paged.

### Enhancements for Group Wake Up

WUS can be distinguished by assigning different sequences to different wireless devices 22.
Further subgrouping, e.g., with sequence and group WUS ID.

In at least one embodiment, the wireless devices 22 monitoring the same PO can be divided into groups to reduce false wake-up. The groups can be based on, e.g., uniform allocation of the wireless devices 22 monitoring the same PO into N groups. Alternatively, the wireless devices 22 can be allocated to different groups based on their traffic pattern. For example, the wireless devices 22 that are woken up frequently are grouped with similar wireless devices 22, while the wireless devices 22 that have less traffic are allocated into other groups.

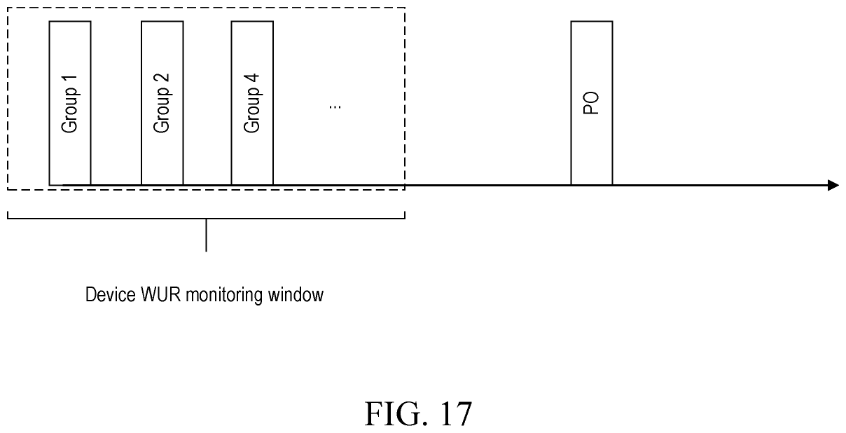

In at least one embodiment, the network node 16 assigns different sequences to distinguish different groups within the same PO. The sequences preferably have as low correlations as possible to distinguish among the groups. The set of sequence can be reused for other POs. As shown in FIG. 17, the WURs 85 monitor the WUS window to check if its group sequence (e.g., group 1, group 2, group 4, etc.) is sent. If the sequence is detected, the WUR 85 stops monitoring the window. There is a trade-off between the number of groups and the false wake-up probability.

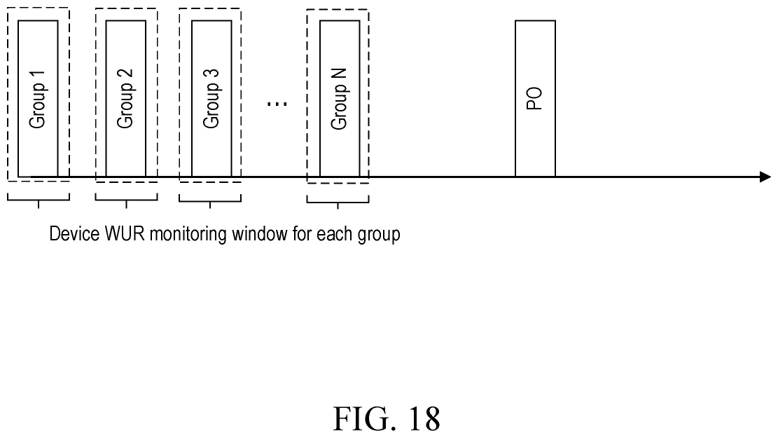

In at least one embodiment, each group (e.g., Group 1, Group 2, etc.) can have its own WUS window as shown in FIG. 18. In this case, the WUR 85 may only monitor for a short period, which will save power consumption. Moreover, only one sequence may be needed, since every group will monitor in order. However, the WUR 85 may miss its window due to being out of sync.

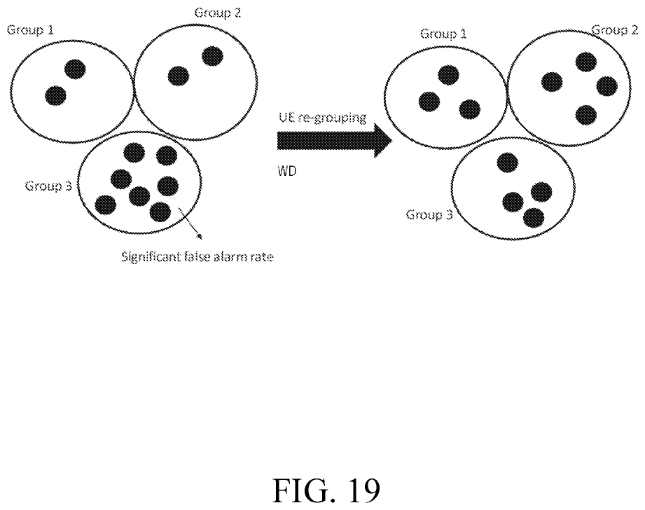

In general, the paging rate depends on the number of wireless devices 22 in a group. Hence, with wireless device 22 grouping, the false paging rate can be higher for a group with more wireless devices 22. In at least one embodiment, dynamic or periodic wireless device 22 grouping based on, e.g., pre-defined rules are applied to minimize the false alarm effects. For example, if the number of wireless devices 22 in a group exceeds a threshold, then wireless device 22 re-grouping is applied to adjust the number of wireless devices 22 in each group. Such re-grouping can be performed by adjusting the size of groups and/or the number of groups. Intuitively, the false alarm rate can be minimized by evenly distributing the wireless devices 22 in different groups, as illustrated in FIG. 19.

In terms of signaling needed for wireless device 22 re-grouping, radio resource control (RRC) configuration/re-configuration, SIB updates, and/or downlink control information (DCI) can be used. Also, pre-defined rules can be applied, for example, after a certain time (e.g., based on a timer), a wireless device 22 group changes automatically. In addition, the existing wireless device 22 grouping equations can be adjusted by adding a new offset value or defining a new function that's applied to the existing wireless device 22 grouping equations.

### WUS Resources

WURs 85 can be separated by assigning different time-frequency resources for WUS.

In at least one embodiment, different WUS durations are used for different WURs 85. For example, k different WUS duration can be considered {s₁, s₂, . . . , sₖ} to target k different sets of WURs 85. In this case, each WUR 85 monitors WUS only for a specific duration sₖ. Examples of sₖ include:
sₖ=k OFDM symbols, slots, or ms
sₖ=2^{k} OFDM symbols, slots, or ms

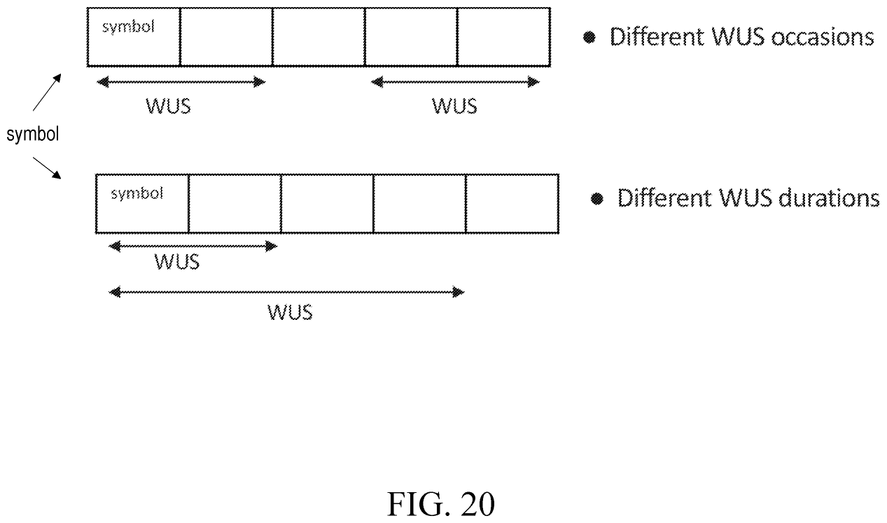

In at least one embodiment, as shown in FIG. 20, different WUS occasions in the time domain are used for different WUS transmissions targeting different WURs 85.

In at least one embodiment, different sets of frequency resources are used for WUS transmissions targeting different WURs 85. This includes using different numbers of resources blocks (PRBs), subcarriers, or bandwidth for WUS. Also, different sets of subcarriers or PRBs can be allocated for WUS.

For example, k different numbers of PRBs {a₁, a₂, . . . , aₖ} can be considered for WUS to target k different sets of WURs 85. This corresponds to different WUS bandwidths.

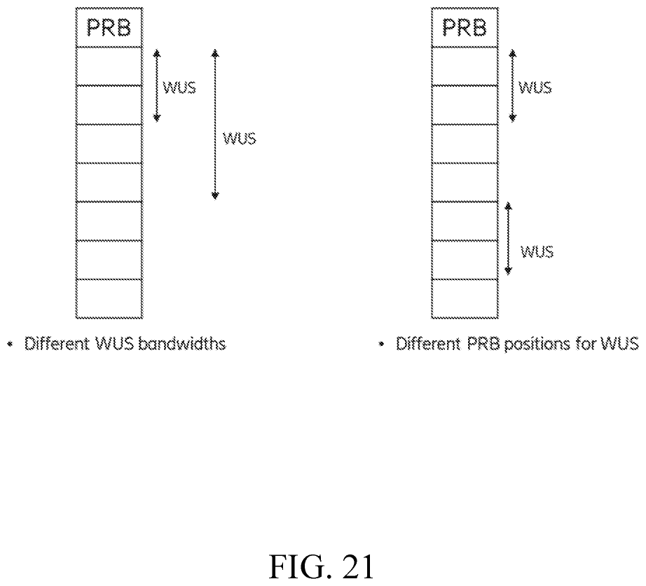

In another example, the available frequency resources for WUS are divided into k chunk of PRBs, as shown in FIG. 21, to target k different sets of WURs 85.

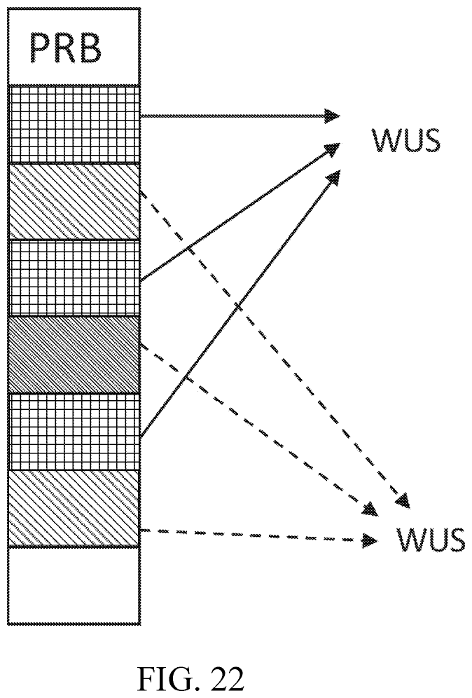

In another embodiment, different frequency-domain interleaving patterns are considered for WUS transmissions. In this case, different sets of contiguous or non-contiguous PRBs are used for WUS transmissions. As shown in FIG. 22, each WUR 85 can received a WUS based on a specific interleaving pattern.

### Multiple Duty-Cycle Configurations

In case of duty-cycled WUR 85 operation, it is possible to separate different WURs 85 using different duty-cycle configurations. The WUR DRX cycle is configured by the network node 16 and is characterized by the following parameters which can be different for different WURs 85:
DRX-inactivity timer
DRX active time/ON duration
DRX inactive time

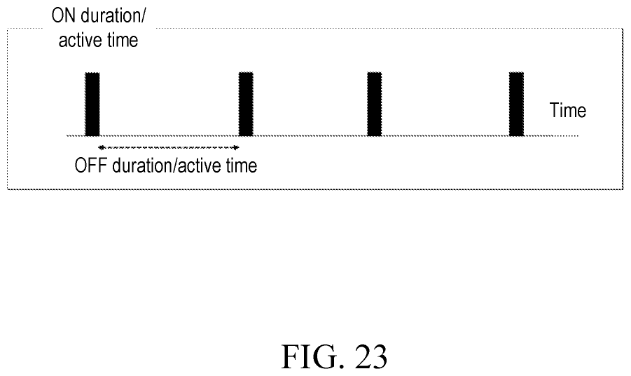

The DRX active time and DRX inactive time are also called DRX ON and DRX OFF, respectively. Durations of the DRX cycles, respectively, are shown in FIG. 23. The DRX inactive time may also be called the non-DRX or non-DRX period.

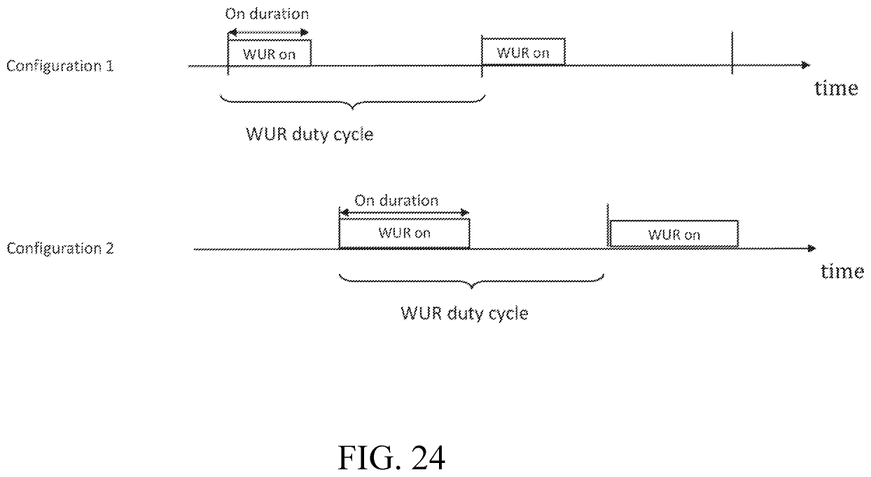

An example of multi duty-cycle configurations for WUR 85 is provided in FIG. 24.

In general, each WUR 85 or group of WURs 85 can be associated with one or more duty-cycled WUR configurations. In case of multiple configurations, the resulting WUR DRX pattern can be formed by super-imposing the WUR 85 on-durations of the multiple WUR DRX patterns.

In one or more of the above embodiments, different options for WUR 85 separations can be configured or dynamically indicated to the wireless device 22. One possible method for dynamic indication is through some information bits included as part of the information contained in the WUS transmission.

### False Alarm Reduction by Introducing No-Wake Up Window for WUR

In principle, a false alarm can happen for every WUR trial during WUR on duration. Therefore, the number of false alarms increases by the WUR 85 activity duration. This can be especially problematic in case of always-on WUR operation or when the WUR ON duration is long.

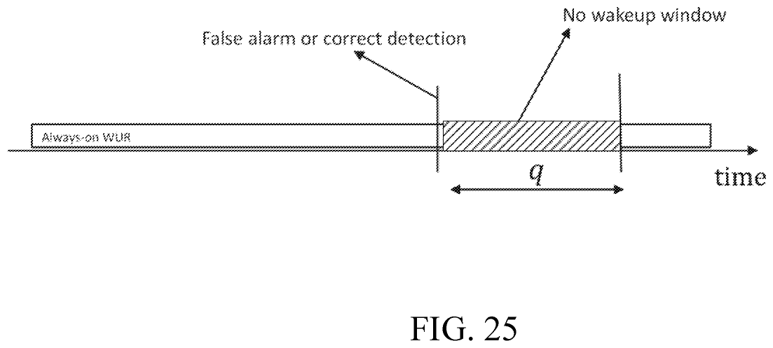

In at least one embodiment, a no-wake up window is introduced for WUR 85 to control the WUR 85 activity and reduce the number of false alarms. During this no-wake-up window, the WUR 85 does not perform any signal detection and hence it does not trigger the main radio. For example, a no-wake up window can be after each time that the WUR 85 correctly or mistakenly triggers the main radio. That is, a no-wake up window is applied after each detection of WUS by the WUR 85 (as illustrated in FIG. 25). Note that, unlike duty-cycle operations, such no-wake up window is not periodic, and it is event-triggered-based.

The length of the no-wake-up window can depend on several factors such as: WUR operation mode, latency target, WUR false alarm probability, and WUS duration.

The length of the no-wake-up window can be configured by a higher-layered parameter as part of WUS monitoring configuration. Alternatively, it can be associated with the active time of the main radio after waking up, i.e., WUR 85 is inactive during the active period of the main radio.

### Wireless Device 22 Main Radio Behavior After WUS Detection and False Wake Ups

False alarm event leads to unnecessary active time of the wireless device 22 main radio and thus waste of energy. From energy efficiency point of view, it is therefore reasonable that the main radio switches back to deep sleep state as soon as possible. However, if there is an up-coming traffic intended for the wireless device 22 soon after it was falsely woken up, it would not be desirable for the wireless device 22 main radio to switch back and forth between On and Off states so often in a short period of time, as there is also some energy loss during the transitions.

In at least one embodiment, after being falsely woken up by WUR 85, the main radio is switched off after a certain configured/predefined time duration during which there is no activity (e.g., paging, PDSCH reception, etc.), i.e., according to an inactivity timer.

In at least one embodiment, after being falsely woken up by WUR 85, the main radio is switched off after not detecting any PDCCH addressing the paging message at the earliest paging occasion after waking up.

### ADDITIONAL EXAMPLES

Example A1. A network node 16 configured to communicate with a wireless device 22, the network node 16 configured to, and/or including a radio interface and/or including processing circuitry configured to:
assign the wireless device 22 to a group, the group including a plurality of wireless device 22s, the plurality of wireless device 22s of the group having a common characteristic that is at least one of monitoring a paging occasion, PO, a traffic pattern, a duty-cycled wake-up radio, WUR, pattern, and a no-wake up window; and transmit a wake-up signal, WUS, to at least one wireless device 22 of the group.

Example A2. The network node 16 of Example A1, wherein the processing circuitry being further configured to configure the group of wireless device 22s with a common WUS window.

Example A3. The network node 16 of Example A1, wherein the group having the common WUR pattern, the common WUR pattern being defined by a parameter including at least one of a discontinuous reception, DRX, inactivity timer, DRX active time, and DRX inactive time.

Example B1. A method implemented in a network node 16, the method including: assigning the wireless device 22 to a group, the group including a plurality of wireless device 22s, the plurality of wireless device 22s of the group having a common characteristic that is at least one of monitoring a paging occasion, PO, a traffic pattern, a duty-cycled wake-up radio, WUR, pattern, and a no-wake up window; and transmitting a wake-up signal, WUS, to at least one wireless device 22 of the group.

Example B2. The method of Example B1, further including configuring the group of wireless device 22s with a common wake-up signal window.

Example B3. The method of Example B1, wherein the group having the common WUR pattern, the common WUR pattern being defined by a parameter including at least one of a discontinuous reception, DRX, inactivity timer, DRX active time, and DRX inactive time.

Example C1. A wireless device 22 configured to communicate with a network node 16, the WD configured to, and/or including a radio interface and/or processing circuitry configured to: receive a wake-up signal, WUS; determine whether the WUS is a false WUS; and if the WUS is a false WUS, switch off a main radio of the wireless device 22 after expiration of a pre-determined time period without detected activity.

Example C2. The wireless device 22 of Example C1, wherein the detected activity includes at least one of a paging transmission and a physical downlink shared channel, PDSCH, transmission.

Example C3. The wireless device 22 of Example C1, wherein the detected activity includes a physical downlink control channel, PDCCH, transmission corresponding to the WUS.

Example D1. A method implemented in a wireless device 22, the method including: receiving a wake-up signal, WUS; determining whether the WUS is a false WUS; and if the WUS is a false WUS, switching off a main radio of the wireless device 22 after expiration of a pre-determined time period without detected activity.

Example D2. The method of Example D1, wherein the detected activity includes at least one of a paging transmission and a physical downlink shared channel, PDSCH, transmission.

Example D3. The method of Example D1, wherein the detected activity includes a physical downlink control channel, PDCCH, transmission corresponding to the WUS.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object-oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:
ADC Analog to Digital Convertor
DRX Discontinuous Reception
LNA Low-noise Amplifier
MIB Master Information Block
OOK On-Off Keying
PBCH Physical Broadcast Channel
PSS Primary Synchronization Signal
PLL Phase Locked Loop
RSRP Reference Signal Received Power
RSRQ Reference Signal Received Quality
SSB Synchronization Signal Block
SSS Secondary Synchronization Signal
SINR Signal to noise plus interference
WUR Wake-Up Radio
WUS Wake-Up Signal

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1.-5. (canceled)

6. A method implemented in a network node configured to communicate with a wireless device, the method comprising:
configuring the wireless device according to a wake-up signal, WUS, scheme, the WUS scheme configured for at least one of:
reducing an occurrence of a false wake-up of a main radio of the wireless device by at least one of:
assigning the wireless device to a group of wireless devices based on a common characteristic, the wireless devices of the group being configured to wake based on receiving a WUS;
configuring the wireless device with a first set of time-frequency resources for a first WUS, the first set of time-frequency resources being different from a second set of time-frequency resources used by another wireless device for a second WUS; and
configuring the wireless device with a first wake-up radio, WUR, discontinuous reception, DRX, cycle different from a second WUR DRX cycle of the another wireless device;
configuring the wireless device with a no-wake-up window, the no-wake-up window having a time period during which a main radio of the wireless device is prevented from waking; and
configuring the wireless device with an inactivity timer configured for, after the occurrence of the false wake up, keeping the main radio awake for the duration of the inactivity timer; and
communicating with the wireless device based on the WUS scheme.

7. The method of claim 6, wherein the common characteristic is at least one of a traffic pattern, a paging occasion, PO, and a WUS window.

8. The method of claim 6, wherein the first set of time-frequency resources and the second set of time-frequency resources differ based on at least one of:
different respective WUS durations;
different respective WUS occasions;
different respective physical resource blocks, PRBs;
different respective WUS bandwidths; and
different respective interleaving patterns.

9. The method of claim 6, wherein the first WUR DRX cycle and the second WUR DRX cycle differ based on at least one of:
different respective DRX start times;
different respective DRX-inactivity timers;
different respective DRX ON durations; and
different respective DRX OFF durations.

10. The method of claim 6, wherein configuring the wireless device with an inactivity timer further comprises configuring the wireless device to cause the main radio to sleep when at least one of:
the wireless device detects no activity during the duration of the inactivity timer; and
the wireless device receives, at the earliest PO following the false wake-up, no physical downlink control channel, PDCCH, signal associated with the false wake-up.

11. A wireless device configured to communicate with a network node the wireless device comprising processing circuitry configured to:
receive a wake-up signal, WUS, scheme, the WUS scheme configured for at least one of:
reducing an occurrence of a false wake-up of a main radio of the wireless device by at least one of:
assigning the wireless device to a group of wireless devices based on a common characteristic, the wireless devices of the group being configured to wake based on receiving a WUS;
configuring the wireless device with a first set of time-frequency resources for a first WUS, the first set of time-frequency resources being different from a second set of time-frequency resources used by another wireless device for a second WUS; and
configuring the wireless device with a first wake-up radio, WUR, discontinuous reception, DRX, cycle different from a second WUR DRX cycle of the another wireless device;
configuring the wireless device with a no-wake up window, the no-wake up window having a time period during which a main radio of the wireless device is prevented from waking; and
configuring the wireless device with an inactivity timer configured for, after the occurrence of the false wake up, keeping the main radio awake for the duration of the inactivity timer; and
communicate with the network node based on the WUS scheme.

12. The wireless device of claim 11, wherein the common characteristic is at least one of a traffic pattern, a paging occasion, PO, and a WUS window.

13. The wireless device of claim 11, wherein the first set of time-frequency resources and the second set of time-frequency resources differ based on at least one of:
different respective WUS durations;
different respective WUS occasions;
different respective physical resource blocks, PRBs;
different respective WUS bandwidths; and
different respective interleaving patterns.

14. The wireless device of claim 11, wherein the first WUR DRX cycle and the second WUR DRX cycle differ based on at least one of:
different respective DRX start times;
different respective DRX-inactivity timers;
different respective DRX ON durations; and
different respective DRX OFF durations.

15. The wireless device of claim 11, wherein configuring the wireless device with an inactivity timer further comprises configuring the wireless device to cause the main radio to sleep when at least one of:
the wireless device detects no activity during the duration of the inactivity timer; and
the wireless device receives, at the earliest PO following the false wake-up, no physical downlink control channel, PDCCH, signal associated with the false wake-up.

16. A method implemented in a wireless device configured to communicate with a network node, the method comprising:
receiving a wake-up signal, WUS, scheme, the WUS scheme configured for at least one of:
reducing an occurrence of a false wake-up of a main radio of the wireless device by at least one of:
assigning the wireless device to a group of wireless devices based on a common characteristic, the wireless devices of the group being configured to wake based on receiving a WUS;
configuring the wireless device with a first set of time-frequency resources for a first WUS, the first set of time-frequency resources being different from a second set of time-frequency resources used by another wireless device for a second WUS; and
configuring the wireless device with a first wake-up radio, WUR, discontinuous reception, DRX, cycle different from a second WUR DRX cycle of the another wireless device;
configuring the wireless device with a no-wake up window, the no-wake up window having a time period during which a main radio of the wireless device is prevented from waking; and
configuring the wireless device with an inactivity timer configured for, after the occurrence of the false wake up, keeping the main radio awake for the duration of the inactivity timer; and
communicating with the network node based on the WUS scheme.

17. The method of claim 16, wherein the common characteristic is at least one of a traffic pattern, a paging occasion, PO, and a WUS window.

18. The method of claim 16, wherein the first set of time-frequency resources and the second set of time-frequency resources differ based on at least one of:
different respective WUS durations;
different respective WUS occasions;
different respective physical resource blocks, PRBs;
different respective WUS bandwidths; and
different respective interleaving patterns.

19. The method of claim 16, wherein the first WUR DRX cycle and the second WUR DRX cycle differ based on at least one of:
different respective DRX start times;
different respective DRX-inactivity timers;
different respective DRX ON durations; and
different respective DRX OFF durations.

20. The method of claim 16, wherein configuring the wireless device with an inactivity timer further comprises configuring the wireless device to cause the main radio to sleep when at least one of:
the wireless device detects no activity during the duration of the inactivity timer; and
the wireless device receives, at the earliest PO following the false wake-up, no physical downlink control channel, PDCCH, signal associated with the false wake-up.

21.-23. (canceled)

24. The wireless device of claim 12, wherein the first set of time-frequency resources and the second set of time-frequency resources differ based on at least one of:
different respective WUS durations;
different respective WUS occasions;
different respective physical resource blocks, PRBs;
different respective WUS bandwidths; and
different respective interleaving patterns.

25. The wireless device of claim 12, wherein the first WUR DRX cycle and the second WUR DRX cycle differ based on at least one of:
different respective DRX start times;
different respective DRX-inactivity timers;
different respective DRX ON durations; and
different respective DRX OFF durations.

26. The method of claim 17, wherein the first set of time-frequency resources and the second set of time-frequency resources differ based on at least one of:
different respective WUS durations;
different respective WUS occasions;
different respective physical resource blocks, PRBs;
different respective WUS bandwidths; and
different respective interleaving patterns.

27. The method of claim 17, wherein the first WUR DRX cycle and the second WUR DRX cycle differ based on at least one of:
different respective DRX start times;
different respective DRX-inactivity timers;
different respective DRX ON durations; and
different respective DRX OFF durations.

28. The method of claim 17, wherein configuring the wireless device with an inactivity timer further comprises configuring the wireless device to cause the main radio to sleep when at least one of:
the wireless device detects no activity during the duration of the inactivity timer; and
the wireless device receives, at the earliest PO following the false wake-up, no physical downlink control channel, PDCCH, signal associated with the false wake-up.
